(19) United States
(12) Patent Application Publication
(10) Pub. No.: US 2007/0143526 A1
(43) Pub. Date: Jun. 21, 2007

(54) Method and apparatus for enhanced randomization function for personal media

(76) Inventor: Raymond C. Bontempi, Jamison, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/312,223

(22) Filed: Dec. 20, 2005

(51) Int. Cl. G06F 12/00

(52) U.S. Cl. 711/100; 707/4

(57) ABSTRACT

A method of playing media files is provided. A plurality of media files is stored. A commonality input that indicates a criterion for commonality is received. Further, a quantitative input is received. The quantitative input indicates a threshold number of the plurality of media files associated with the criterion for commonality. The quantitative input is a number of two or more. The common media files are randomly selected from the plurality of media files according to the commonality input and the quantitative input. The media files are played consecutively within the context of an overall randomized playback context.

### BACKGROUND

1. Field

A system and method are disclosed which generally relate to media files, and more specifically to randomization of the media files for playback.

2. General Background

The use of devices which play media files has tremendously grown in recent years, from PC based, to mobile and auto based devices. The term “media files” is intended to mean any file that contains information including, but not limited to, video and/or audio. For instance, a digital music file such as an mp3 file would be considered a media file, as would a digital photo such as a jpg. Media players were introduced to consumers to allow them to access these media files.

Although media devices have evolved to play different types of media files, they have not kept up with consumers' desire for interesting ways to play these files. Existing players allow creation of playlists, or photo albums, to group files logically (by album, year, artist etc.), and allow random playback of either the entire library, or randomized playback of playlists, albums etc. The randomized playback of media can be a much more compelling capability.

### SUMMARY

One aspect of the disclosure is directed to a method of playing media files. A plurality of media files is stored. A commonality input that indicates a criterion for commonality is received. Further, a quantitative input is received. The quantitative input indicates a threshold number of the plurality of media files associated with the criterion for commonality within the context of a randomized playback. The quantitative input is a number of two or more. The media files are randomly selected from the plurality of media files according to the commonality input and the quantitative input. The media files are played consecutively. The effect for the user is that within a randomized playback, two or more similar files get played consecutively (photos, music or video) before a new random file is chosen. This could be three songs by each artist (randomly chosen), or 4 pictures from each Christmas (randomly chosen). This gives a substantially different experience to the user from a standard single randomized playback.

In one aspect of the disclosure, a method of playing media files is provided. A plurality of media files is stored. A commonality input that indicates a criterion for commonality is received. Further, a quantitative input is received. The quantitative input indicates a threshold number of the plurality of media files associated with the criterion for commonality. The quantitative input is a number of two or more. A first set of media files are randomly selected from the plurality of media files according to the commonality input and the quantitative input. Further, a second set of media files are randomly selected from the plurality of media files according to the commonality input and the quantitative input. The first set of media files is played consecutively. After the first set of media files is played, the second set of media files is played consecutively.

In one aspect of the disclosure, a media system is provided. A media storage stores media files. A first input receives a commonality input that indicates a criterion for commonality. Further, a second input receives a quantitative input that indicates a threshold number of the plurality of media files associated with the criterion for commonality. The quantitative input is a number of two or more. A processor randomly selects media files from the plurality of media files according to the commonality input and the quantitative input, and plays the selected media files consecutively.

### DRAWINGS

The above-mentioned features and objects of the present disclosure will become more apparent with reference to the following description taken in conjunction with the accompanying drawings wherein like reference numerals denote like elements and in which:

FIG. 1 illustrates a block diagram of the internal components of a media device that can be utilized in conjunction with the enhanced randomization function.

FIG. 2A illustrates the external components of one embodiment of the personal media device that can be utilized in conjunction with the enhanced randomized function.

FIG. 2B illustrates an embodiment of the media device depicted in FIG. 2A in which the enhanced randomized play button is activated so that the commonality input can be chosen.

FIG. 2C illustrates an embodiment of the media device depicted in FIG. 2A in which the enhanced randomization play button is activated so that the quantitative input can be chosen.

FIG. 3 illustrates the media device as a home media server.

FIG. 4 illustrates a process for playing media files.

FIG. 5 illustrates a process in which the media files are selected according to the enhanced randomization.

FIG. 6 illustrates another process for playing media files in which the media files to be played can be predetermined so that a queue can established.

### DETAILED DESCRIPTION

To provide users with a more enjoyable and less thought intensive approach to playing media files, an enhanced randomization method is provided. Generally speaking, a randomization is a random assortment of files, stored in a digital library, for playback. The enhanced randomized function, as will be described below, intelligently makes a random selection according to inputs received from a user. These inputs require the user to provide a minimal amount of information to provide a random selection that the user is likely to enjoy at the particular time that the user provided the inputs.

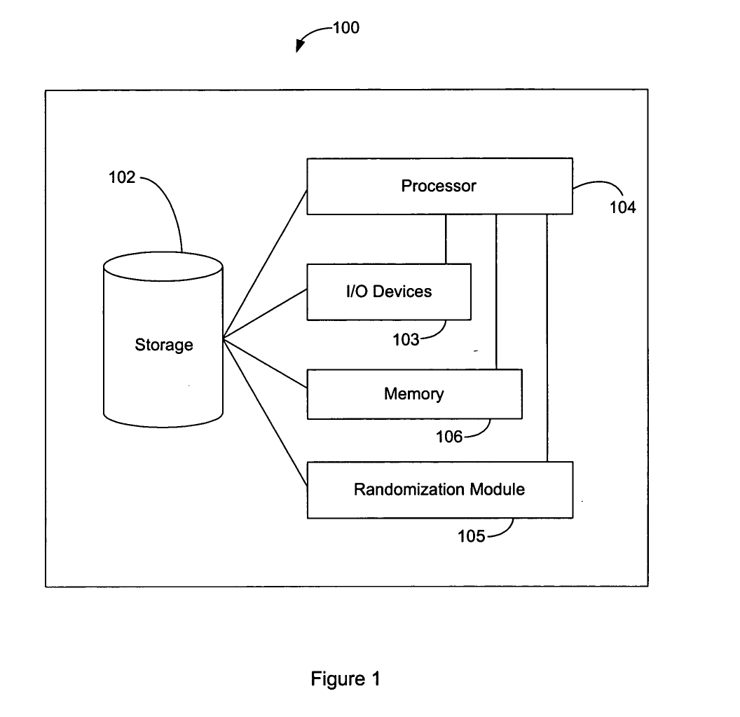

FIG. 1 illustrates a block diagram of the internal components of a media device 100 that can be utilized in conjunction with the enhanced randomized function. The media device 100 can be any device that plays back a media file. The media device 100 can be an mp3 player, home media server, personal computer, cell phone, etc.

The media device 100 has a storage 102 that contains a library of media files. The storage 102 can be a hard disk or any other medium known to one of ordinary skill in the art that can store media files. In one embodiment, the storage 102 can store a mixture of different types of media files, e.g., music, photo, and video files. In other embodiments, the storage can be limited to storing just one type of media file, e.g. music files. In addition, the media device 100 has a processor 104 that moves personal media files from the storage 102 to a memory 106 for playback. The media device 100 also has a randomization module 105 that communicates with the processor 104 for randomizing playback. Further, the media device 100 has various input/output devices 103 (e.g., a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)) for receiving input.

In one embodiment, the processor 104 is a central processing unit (“CPU”). Further, in one embodiment, the memory 106 is a random access memory (“RAM”) and/or read only memory (“ROM”).

It should be understood that the randomization module 105 can be implemented as one or more physical devices that are coupled to the processor 104 through a communication channel. Alternatively, the randomization module 105 can be represented by one or more software applications (or even a combination of software and hardware, e.g., using application specific integrated circuits (ASIC), where the software is loaded from a storage medium, (e.g., a magnetic or optical drive or diskette) and operated by the processor 104 in the memory 106 of the computer. As such, the randomization module 105 (including associated data structures) of the present disclosure may be stored on a computer readable medium, e.g., RAM memory, magnetic or optical drive or diskette and the like.

The media files can be stored on the storage 102 in a variety of ways. For instance, some of the media files can be downloaded from a server or another media device through a network such as the Internet, Local Area Network (“LAN”), or Wide Area Network (“WAN”). Some of the media files may come preloaded on the storage. Further, some of the media files may be transferred to the media device 100 from another storage medium such as a memory card. In addition, some of the media files may be transferred from the media device 100 through another media device. Data transmission between devices can be accomplished through techniques such as Infrared signals or data transfer through a cable connected to the devices.

The media device 100 can have a communications device for connecting with the Internet. For instance, the media device 100 can have a modem. The processor 104 can provide instructions to the communications device for transferring files over a network. In another embodiment, the media device 100 can have a port for connecting the media device 100 to another media device, a personal computer, a networked device, etc.

In one embodiment, the storage 102 can be an internal component to the media device 100. In another embodiment, the storage 102 can be an external component that is inserted into the media device 100. For instance, the storage can be a memory card that is inserted through a USB port on the media device 100. One skilled in the art will be familiar with a variety of other portable external devices that a user can insert into the media device 100 so that the user can carry his or her library with them for playing in various locations.

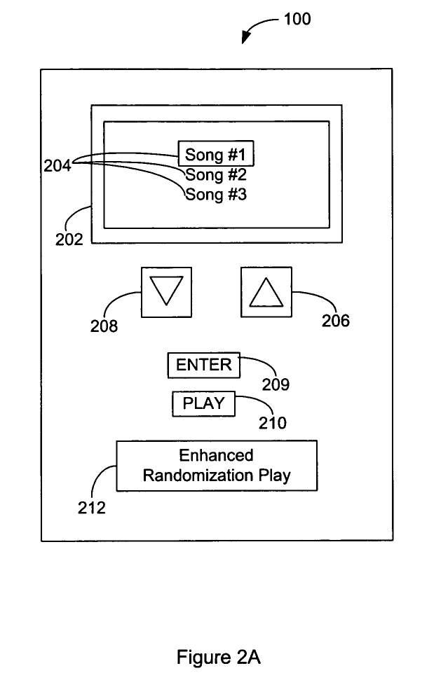

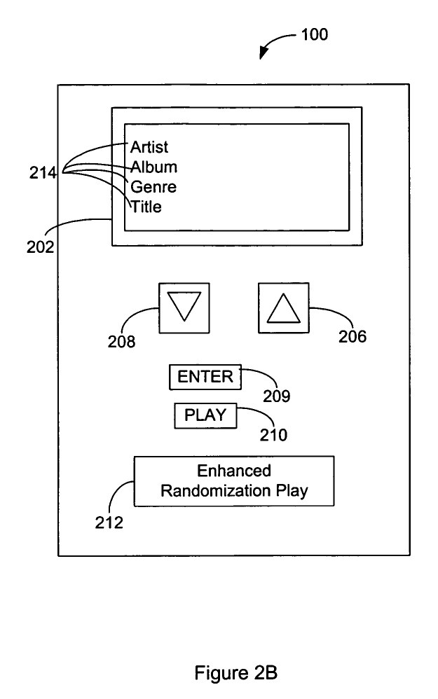

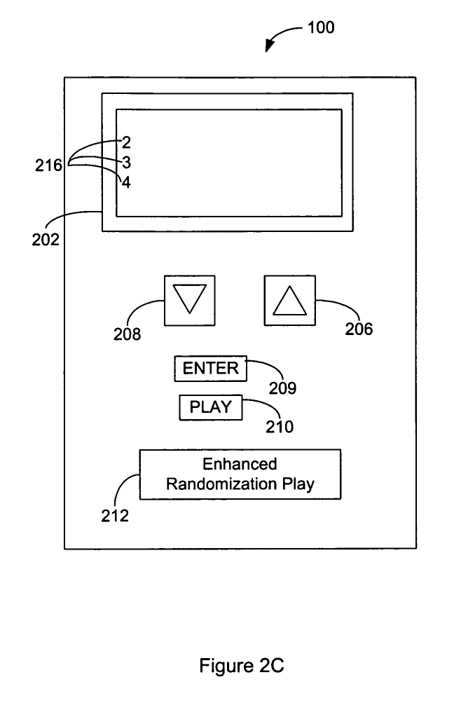

FIG. 2A illustrates the external components of one embodiment of the personal media device 100 that can be utilized in conjunction with the enhanced randomized function. For ease of reference, the media device 100 is illustrated in FIG. 2 as being an mp3 player that plays music files.

The media device 100 has a display 202 that can be used to provide output to the user. For instance, the display 202 can be utilized to illustrate contents of a digital library of media files, such as songs 204. In one embodiment, the user can use navigation buttons such as an up button 206 or a down button 208 to navigate through the list of songs 204. However, other embodiments may use different navigation mechanisms known to one skilled in the art, such as a dial. Further, the contents of the digital library of media files do not have to be displayed vertically, but rather can be displayed horizontally, in a circle, or any other format known to one skilled in the art.

After a user navigates to a song 208, the user can then play the song by pressing the play button 210. In other embodiments, other forms for play activation can be used. For instance, a voice recognition system can be built into the media device 100 so that a voice command can be provided to play the desired song.

However, the user may not want to navigate through hundreds of songs. By pressing an enhanced randomization button 212, the user provides an instruction to the processor to find, from the songs stored on the storage, a random selection for playback. The processor does not calculate a completely random selection as the processor obtains input from the user that helps determine the selection. In essence, the user provides a theme that multiple songs should follow. The processor can then intelligently make a random selection of songs according to that theme so that the user has to provide only a minimal amount of work to enjoy a series of media files.

In particular, the processor 104 receives a commonality input and a quantitative input from the user. The commonality input is essentially a categorical criterion provided by the user that describes the common theme a series of media files should have. In one embodiment, the commonality input can be “artist.” By inputting “artist” for the commonality input, the user is indicating that the random selection should have multiple songs by the same artist. In another embodiment, the commonality input can be “album.” By inputting “album” for the commonality input, the user is indicating that the random selection should have multiple songs that are on the same album. In another embodiment, the commonality input can be “genre.” By inputting “genre” for the commonality input, the user is indicating that the random selection should have multiple songs that are of the same genre. In yet another embodiment, the commonality input can be “title.” By inputting “title” for the commonality input, the user is indicating that the random selection should have multiple songs that have the same title. In an alternative embodiment, the random selection should have songs that have portions of titles which are similar. In yet another alternative embodiment, the user can enter a text phrase which should be present in the title of each of the songs in the random selection.

The quantitative input indicates how many songs from each category will be part of the enhanced randomization. For instance, the user may indicate a commonality input of “artist” and a quantitative input of two to instruct the media device 100 that the enhanced randomization should include at least two songs from the same artist. The processor 104 then randomly selects two songs from the songs of a particular artist stored on the storage 102. In one embodiment, multiple artists are selected so that the enhanced randomized function includes multiple artists with two random songs from each. The songs from each artist are played consecutively, meaning that there is no interruption by during the playing of a group of songs from on artist by another artist. The term “consecutive” is not intended to mean that the songs randomly selected are to be played in any particular order, but rather that there is not interruption in the playing of the randomly selected songs. Further, the explanation of the term “consecutively” is intended to apply any commonality input and is not intended to be limited to “artist.” In addition, the quantitative input can be any number that is two or greater.

In one embodiment, the processor 104 searches for all the files that could potentially meet the commonality input. The processor 104 then performs the random selection from this set of data. For instance, if the commonality input is “artist,” the processor 104 can first search to see what artists have more than one song in the digital library. The processor 104 can then randomly select a number of songs from each artist, depending on the quantitative input. In yet another embodiment, the processor 104 also randomly selects the artists from the artists that have more than one song in the digital library. This additional random selection may take place in order to keep the length of the enhanced randomization reasonable. In one embodiment, the user provides the media device 100 with a length for the reasonable enhanced randomization. The length may be in terms of time duration or number of songs.

Further, in another embodiment, the enhanced randomization only consists of media files resulting from the commonality input and the quantitative input. In other words, only groups of two or more songs, each having a theme according to the commonality input, will be placed in the enhanced randomization. In yet another embodiment, the media files resulting from the commonality input and the quantitative input are a subset of the enhanced randomization. For instance, half of the enhanced randomization may include groups of two or more songs according to the commonality input while the other half of the enhanced randomization may include a random assortment of songs not belonging to a group determined by the commonality input. In one embodiment, the user determines the how much of the enhanced randomization is determined by the commonality input and the quantitative input by providing an input. For example, the user can provide a percentage of how much of the enhanced randomization should be determined by the commonality input and the quantitative input.

In yet another embodiment, the quantitative input provides a minimum for which the processor 104 can make random selections. The processor 104 would randomly determine different sizes of groups. For instance, the processor 104 would search for all the artists with two songs, three songs, four songs, etc. and then randomly select how many songs will be used so that the user is provided with further variety. For example, an artist may have four songs in the digital library, but the processor 104 may choose only three songs to use. In an alternative embodiment, the user can also provide a maximum so that the user does not end up hearing too many songs by any one artist.

FIG. 2B illustrates an embodiment of the media device 100 depicted in FIG. 2A in which the enhanced randomization play button 212 is activated so that the commonality input can be chosen. The display 202 illustrates a variety of exemplary commonality inputs 214 such as artist, album, genre, and title. This list of examples is not meant to be exhaustive. The user can use the up button 206 or the down button 208 to navigate through the commonality inputs to make a selection. The user can then press the enter button 209 once a selection is made. In an alternative embodiment, the media device 100 has a keypad or keyboard which the user can use to manually enter in or highlight a selection of the commonality input.

FIG. 2C illustrates an embodiment of the media device 100 depicted in FIG. 2A in which the enhanced randomization play button 212 is activated so that the quantitative input can be chosen. The display 202 illustrates a variety of exemplary quantitative inputs 216 such as two, three, and four. This list of examples is not meant to be exhaustive. In an alternative embodiment, the media device 100 has a keypad or keyboard which the user can use to manually enter in or highlight a selection of the quantitative input.

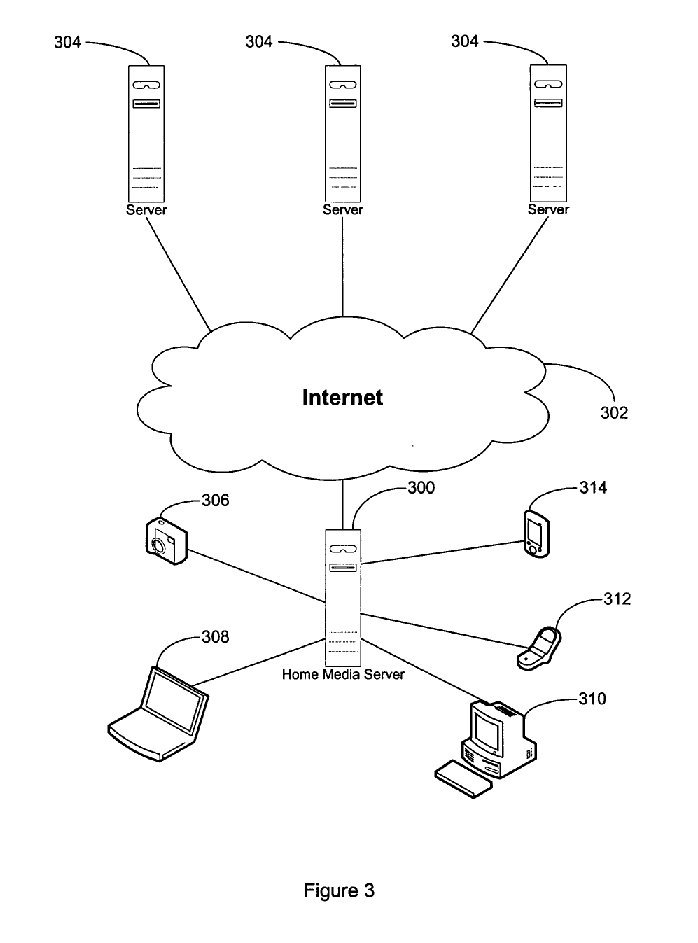

FIG. 3 illustrates the media device 100 as a home media server 300. Accordingly, the home media server 300 is a home entertainment system that is coupled to a display such as a television. Further, the home media server 300 can connect through the Internet 302 to servers 304. The home media server 300 can download media files from the servers 304. In addition, the home media server 300 can download media files from various local devices such as a camera 306, a laptop 308, a personal computer 310, a cell phone 312, or a personal digital assistant (“PDA”) 314. As examples, the home media server 300 can use the enhanced randomization function for a slide show of digital photographs, viewing of video files, listening to music files, or a combination of some of these different types of presentations.

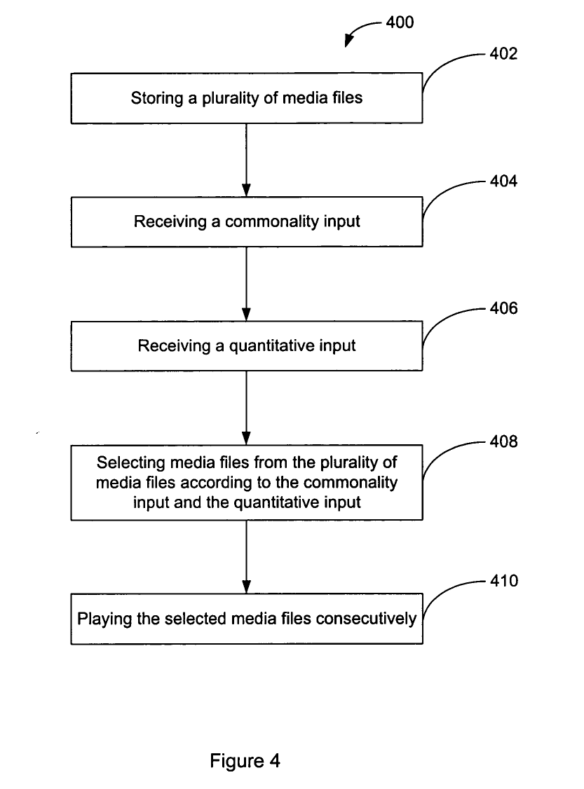

FIG. 4 illustrates a process 400 for playing media files. In one embodiment, the process 400 is implemented on the media device 100 by the processor 104. At a process block 402, a plurality of media files are stored. In addition, at a process block 404, a commonality input is received. Further, at a process block 406 a quantitative input is received. At a process block 408, the media files are selected from the plurality of media files according to the commonality input and the quantitative input. Finally, at a process block 408, the selected media files are played consecutively.

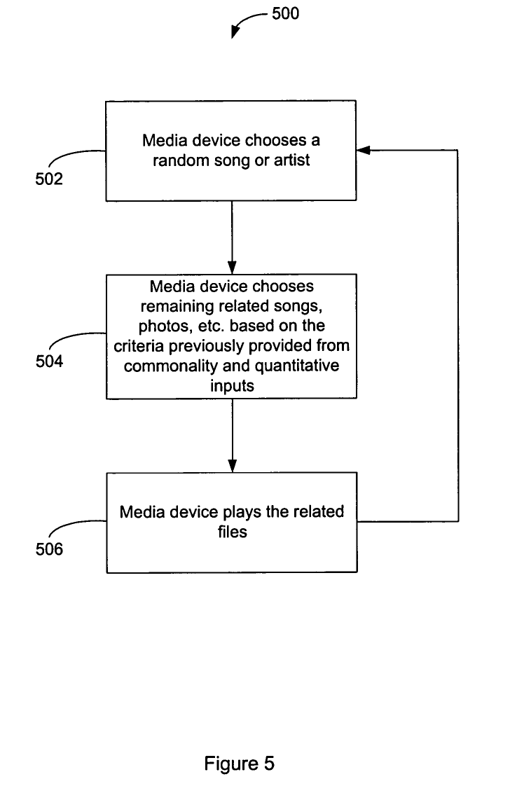

FIG. 5 illustrates a process 500 in which the media files are selected according to the enhanced randomization. The process 500 is one embodiment of the selection process illustrated in the process block 408 in FIG. 4. For exemplary purposes only, the process 500 is illustrated for the commonality input being an artist of music songs. At a first process block 502, the media device 100 chooses a random song or artist. In one embodiment, the media device 100 randomly selects an artist and a song associated with the artist. In another embodiment, the media device 100 randomly selects a song and thereby determines the artist associated with the song. At a process block 504, the media device 100 chooses the remaining number of songs based on the quantitative input. Finally, at a process block 506, after all the songs have been played, the process 500 loops back to the process block 502 to randomly select another artist or song. The loop illustrated in FIG. 5 is designed to go infinitely so that the user is not constrained by a limited number of iterations. As a result, a previous artist or song may get played in a later iteration. Further, in one embodiment, the media device 100 can receive an input from the user that restricts the number of iterations that the loop makes. In yet another embodiment, the media device 100 makes a random number of iterations.

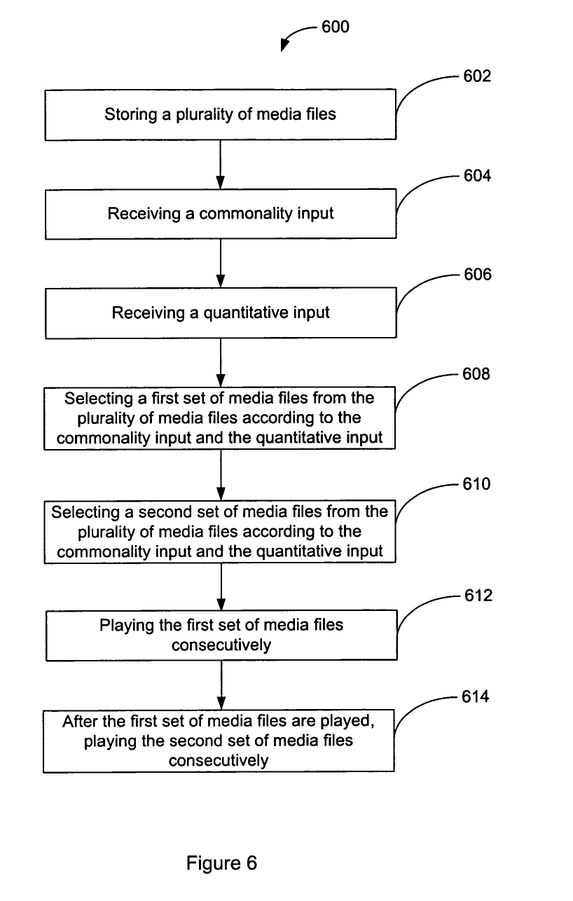

FIG. 6 illustrates a process 600 for playing media files in which the media files to be played can be predetermined so that a queue can established. In one embodiment, a play list can be used for the predetermined media files. For example, the play list can have a queued number of artists determined prior to the playing of actual songs. At a process block 602, a plurality of media files are stored. In addition, at a process block 604, a commonality input is received. Further, at a process block 606 a quantitative input is received. At a process block 608, a first set of media files are selected form the plurality of media files according to the commonality input and the quantitative input. Subsequently, at a process block 610, a second set of media files are selected form the plurality of media files according to the commonality input and the quantitative input. At a process block 612, the first set of media files is played consecutively. Finally, at a process block 614, after the first set of media files is played, the second set of media files is played consecutively. The user of two media files is merely exemplary. Any arbitrary number of sets of media files can be used.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method of playing media files, the method comprising:
storing a plurality of media files;
receiving a commonality input that indicates a criterion for commonality;
receiving a quantitative input that indicates a threshold number of the plurality of media files associated with the criterion for commonality, the quantitative input being a number of two or more;
randomly selecting media files from the plurality of media files according to the commonality input and the quantitative input; and
playing the selected media files consecutively.

2. The method of claim 1, further comprising receiving an enhanced randomization command.

3. The method of claim 1, further comprising automatically, without input from the user, randomly selecting additional media files from the plurality of media files according to the commonality input and the quantitative input after the playing of the selected media files consecutively has completed.

4. The method of claim 1, wherein the criterion for commonality is an artist.

5. The method of claim 1, wherein the criterion for commonality is an album.

6. The method of claim 1, wherein the criterion for commonality is a genre.

7. The method of claim 1, wherein the criterion for commonality is a title.

8. The method of claim 1, wherein the plurality of media files includes music files.

9. The method of claim 1, wherein the plurality of media files includes video files.

10. The method of claim 1, wherein the plurality of media files includes digital photographs.

11. The method of claim 1, wherein the plurality of media files includes music files and digital photographs.

12. The method of claim 1, wherein the plurality of media files includes video files and digital photographs.

13. The method of claim 1, wherein the plurality of media files includes music files and video files.

14. A method of playing media files, the method comprising:
storing a plurality of media files;
receiving a commonality input that indicates a criterion for commonality;
receiving a quantitative input that indicates a threshold number of the plurality of media files associated with the criterion for commonality, the quantitative input being a number of two or more;
randomly selecting a first set of media files from the plurality of media files according to the commonality input and the quantitative input;
randomly selecting a second set of media files from the plurality of media files according to the commonality input and the quantitative input;
playing the first set of media files consecutively; and
after the first set of media files is played, playing the second set of media files consecutively.

15. The method of claim 14, further comprising receiving an enhanced randomization command.

16. A media system comprising:
a media storage that stores media files;
a first input that receives a commonality input that indicates a criterion for commonality;
a second input that receives a quantitative input that indicates a threshold number of the plurality of media files associated with the criterion for commonality, the quantitative input being a number of two or more; and
a processor that randomly selects media files from the plurality of media files according to the commonality input and the quantitative input, and plays the selected media files consecutively.

17. The media system of claim 16, wherein the media system is a home media server.

18. The media system of claim 16, wherein the media system is a personal computer.

19. The media system of claim 16, wherein the media system is wireless.

20. The media system of claim 16, wherein the media system is an mp3 player.
